(19) United States
(12) Patent Application Publication
(10) Pub. No.: US 2013/0209626 A1
(43) Pub. Date: Aug. 15, 2013

(54) GRINDING OF COFFEE BEANS

(71) Applicants: Marco Keller, Bissegg (CH); Peter Braun, Kreuzlingen (CH)

(72) Inventors: Marco Keller, Bissegg (CH); Peter Braun, Kreuzlingen (CH)

(73) Assignee: BUEHLER AG, Uzwil (CH)

(21) Appl. No.: 13/812,669

(22) PCT Filed: Jul. 25, 2011
(86) PCT No.: PCT/EP2011/062717

§ 371 Date: Feb. 23, 2013

(30) Foreign Application Priority Data
Jul. 28, 2010 (EP) 10171084.6

(51) Int. Cl. A23F 5/08; A47J 42/38

(52) U.S. Cl. CPC A23F 5/08; A47J 42/38
USPC 426/233; 426/518; 241/65; 241/66; 241/33

(57) ABSTRACT

A device for processing roasted coffee beans, including a unit for grinding the beans, and a method for processing coffee beans, wherein the coffee beans are ground and the temperature of the coffee to be ground, at least at the start of the grinding operation, is between 30° C. and 150° C., in particular between 35° C. and 100° C., preferably between 40° C. and 90° C., and more preferably between 40° C. and 60° C. For this purpose, the device includes a thermal unit.

The invention relates to an apparatus for processing roasted coffee beans, having a unit for grinding the beans, and to a method for processing coffee beans, wherein the coffee beans are ground and the temperature of the grinding product, at least at the start of the grinding operation, is between 30° C. and 150° C., particularly between 35° C. and 100° C., preferably between 40° C. and 90° C., particularly preferably between 40° C. and 60° C.

In the conventional processing process for producing ground and packaged coffee, green coffee is first of all roasted at temperatures of greater than 150° C. and then cooled by means of ambient air, this resulting typically in a bean temperature of about 5° C. above room temperature, i.e. a bean temperature of between 20-40° C.

Subsequently, the coffee is ground, wherein the grinding tools, for example the rollers, are cooled and an increase in the temperature of the ground coffee is largely avoided. Final temperatures of the grinding product are therefore in the range of 20-40° C.

Pyrolytic reactions, in which water and CO₂ are released, occur during the final part of roasting. Since the cell structure of the coffee bean tends to be thick-walled, the CO₂ cannot escape during the process, and as a result a CO₂-related overpressure, which can be up to several bar of overpressure, forms in the cells toward the end of roasting.

During the subsequent grinding process, the cells are broken down depending on the degree of grinding, with a portion of undamaged cells usually remaining. If the ground coffee is now packaged directly after grinding, degassing continues, and this can lead to bulging, if not even to bursting of the pack. For this reason, the coffee is put into interim storage before packaging in order to achieve sufficient degassing. To this end, in the conventional processing process, the coffee is stored in silos until the release of CO₂ is complete and is then packaged.

Therefore, space and time have to be allowed during the processing process.

Furthermore, flavors and aromas also escape during open interim storage and oxidation of the coffee can occur, this impairing the quality and the durability of the coffee under certain circumstances.

There is therefore a need to shorten interim storage. This can be achieved, for example, in that, as disclosed for example in EP1363401, the pack of ground coffee is equipped with a one-way valve which allows degassing of CO₂ but prevents the ingress of oxygen. However, these valves are suitable essentially only for relatively large containers.

Alternatively, Bezman et al., “Method for Continuous Monitoring Rates of CO₂ Release from R&G Coffee” (22nd International Conference on Coffee Science, Campinas Colloquium, 2008), for example, disclose that degassing accelerates at a higher storage temperature. However, this procedure requires additional outlay on equipment and expenditure of energy during interim storage.

It is therefore the object to avoid the disadvantages of the prior art and to provide an apparatus and a method for processing coffee, by way of which degassing of ground coffee in the pack can be largely prevented, and which do not unnecessarily prolong the processing process and/or make it more expensive.

The object is achieved by an apparatus for processing roasted coffee beans, wherein the apparatus comprises a thermal unit which ensures that the temperature of the roasted coffee beans during the grinding operation, at least at the start of the grinding operation, is between 30° C. and 150° C., particularly between 35° C. and 100° C., preferably between 40° C. and 90° C., more preferably between 40° C. and 60° C., wherein grinding takes place particularly in a roller mill having one, two or more passages.

A passage generally consists of one pair of rollers. Successive passages can be created by adding individual rollers. Preferably, each passage consists of a separate pair of rollers.

With a roller mill, smaller batches of grinding product can be processed in batchwise operation, but preferably larger quantities of grinding product are processed virtually continuously, with the grinding product being fed to the grinder via a feeding device and being conveyed away from the grinder via a discharging device. In continuous or virtually continuous processing, the entire grinding product is guided essentially only once via the same pair of rollers during the grinding operation, and therefore grinding product can be fed in continuously.

Preferably, the apparatus according to the invention comprises a modular roller mill which can optionally be equipped with one or more roller passages.

Surprisingly, it has been found that it is advantageous not to cool the roasted coffee beans to excessively low temperatures in preparation for the subsequent grinding process, or during the grinding process, as is usually done, but to transfer them into the unit for grinding and/or process them therein when they are still warm.

In order to allow this operation to proceed in a controlled manner, according to the invention, the apparatus contains a thermal unit. The thermal unit ensures that the coffee is transferred into the grinding unit, particularly the roller mill, at the desired temperatures and/or is ground at the desired temperatures, and prevents the coffee from being processed when it is too cold or too warm. To this end, either the cooling operation can be broken off in a controlled manner after roasting or active heating can take place.

Warm grinding encourages degassing during the grinding operation, and in addition there is no need to subsequently heat the ground coffee to a higher temperature level during storage. Degassing is accelerated in this way, the downtime is shortened and additional input of energy after grinding is generally no longer necessary.

In order to counteract undesired emission of aroma, the thermal unit can be coupled to a system for aroma protection or for aroma recovery, for example to an adsorption system.

In an advantageous embodiment of the invention, the thermal unit influences the temperature of the roasted coffee prior to grinding. To this end, the thermal unit comprises a temperature-control device and a device for feeding grinding product, particularly a device for feeding grinding product into a roller mill, wherein the temperature-control device and the device for feeding grinding product are designed such that the temperature of the roasted coffee beans is controllable to temperatures of the grinding product of 30° C. and 150° C. for the start of the grinding operation, and the roasted coffee beans are grindable at these temperatures.

Preferably, the temperature-control device is a cooling apparatus, in which the roasted coffee beans are cooled to a temperature of between 30° C. and 150° C., particularly between 35° C. and 100° C., preferably between 40° C. and 90° C., particularly preferably between 40° C. and 60° C., immediately after roasting. By means of the device for feeding grinding product, the coffee beans are transferred at this temperature into the unit for grinding.

Alternatively, the temperature-control device can be an apparatus for heating roasted, already cooled coffee to a temperature of between 30° C. and 150° C., particularly between 35° C. and 100° C., preferably between 40° C. and 90° C., particularly preferably between 40° C. and 60° C.

In a further advantageous embodiment of the apparatus according to the invention, the thermal unit influences the temperature of the roasted coffee during grinding. To this end, the thermal unit comprises a temperature-control device for the unit for grinding, particularly for a roller mill, said temperature-control device being designed such that the temperature of the grinding product is maintainable between 30° C. and 150° C., particularly between 35° C. and 100° C., preferably between 40° C. and 90° C., particularly preferably between 40° C. and 60° C.

It may suffice for the grinding product to be at the desired temperature at the start of the grinding operation, but preferably the temperature of the grinding product is influenced throughout the grinding operation.

The temperature-control device for the unit for grinding can bring the entire unit for grinding to the target temperature or the target temperature range, or only the grinding tools.

In particular, the temperature of one or more passages of the roller mill is controlled in a suitable manner.

Preferably, the temperature-control device for the unit for grinding is a temperature-control device for grinding tools, for example the grinding rollers. During the grinding operation in at least one grinding stage, the temperature-control device maintains the grinding tools at a temperature or in a temperature range of between 30° C. and 150° C., particularly between 35° C. and 120° C., more particularly between 40° C. and 110° C., preferably between 40° C. and 90° C., particularly preferably between 40° C. and 60° C. or between 60° C. and 80° C.

Advantageously, the respective temperatures of separate roller passages or of individual rollers can be regulated individually, i.e. independently of one another. A temperature profile along the grinding path is thus producible.

Channels, through which cooling water can be passed, frequently pass through grinding tools, for example grinding rollers. These channels can be used to introduce a temperature-control liquid into the grinding tools, wherein the temperature of the temperature-control liquid, for example water or oil, is controllable and/or regulatable such that the tools are brought to the desired target temperature, or the desired target temperature range.

In order to regulate the temperature of the temperature-control liquid, the temperature-control unit comprises preferably a temperature sensor, which is arranged in the roller. The temperature of the temperature-control liquid in the rollers is a good measure for the roller temperature.

The temperature of the grinding tools can also be controlled thermoelectrically, for example via a Peltier element.

Advantageously, the temperature of the grinding product is settable via the thermal unit. To this end, the cooling device and/or the temperature-control device comprises preferably input means for inputting the target temperature or the target temperature range of the grinding product, in the present case of the roasted coffee beans. The input means can be for example a switch, a slide, a rotary knob and/or a keyboard. The input means can be provided with an indicator, for example a display, which indicates the selectable temperatures, the selected temperature and/or the selected temperature range. The thermal unit can also be connected to a processor system, via which the temperature or the temperature range is input into the thermal unit directly or depending on other parameters.

In order to ensure that the grinding product is at the desired target temperature, or a temperature in the desired target temperature range, the apparatus comprises preferably a measuring device for measuring the temperature of the roasted coffee before, during and/or after grinding.

The temperature of the grinding product is measured preferably by measuring the temperature of the surrounding air or by bulk material measurement, in which the temperature sensor is held in the bulk material or the bulk material flows around said temperature sensor. In order to measure the temperature, the sensor can be brought into direct contact with the bulk material or with the surrounding air or the temperature is measured in a contactless manner, for example optically.

Preferably, the apparatus according to the invention comprises a regulating device for controlling the temperature of the unit for grinding the beans, particularly of the grinding tools, depending on the temperature of the grinding product. The temperature of the grinding unit is then controlled automatically depending on the temperature of the grinding product and depending on the selected target temperature, or the selected target temperature range. If the grinding product emerging from the grinding unit is too cold, the temperature is raised, if the emerging grinding product is too warm, the temperature is lowered.

Advantageously, the apparatus according to the invention has an input and comparison means, by way of which the temperature of the grinding product is determined depending on the desired particle size distribution of the ground coffee.

It has been shown that more finely ground coffee stores much less CO₂ than coarsely ground coffee, and therefore the degassing process generally needs to be forced less strongly.

The expenditure of energy can therefore be optimized when the temperature of the grinding product is controlled in a manner encouraging degassing only to the extent that this is necessary. Depending on the particle size distribution of the ground coffee, the temperature of the grinding product can thus be selected in a targeted manner, the temperatures tending to be higher for coarser coffee and lower for coffee to be ground finely.

Regulation can take place on the basis of a table stored in a process system, said table establishing the relationship between particle size and temperature for degassing. The data in the table can be collected empirically.

Regulation can also take place on the basis of data measured online or inline, for example on the basis of the particle sizes after grinding, the CO₂ content before and/or during and/or after grinding, or on the basis of other parameters, which are directly or indirectly relevant to the process.

Regulation can be based on expert knowledge or other artificial intelligent systems of control and/or regulation technology.

The object is also achieved by a method for processing coffee beans, in which it is ensured that the temperature of the grinding product, at least at the start of the grinding operation, in particular in a roller mill having one or more passages, is between 30° C. and 150° C., particularly between 35° C. and 100° C., preferably between 40° C. and 90° C., particularly preferably between 40° C. and 60° C., wherein grinding takes place particularly in a roller mill having one, two or more passages.

To this end, a method according to the invention for processing coffee beans comprises for example the following method steps of: (i) roasting the coffee beans; (ii) cooling the coffee beans to temperatures greater than 66° C.; (iii) grinding the coffee beans at temperatures of between 66° C. and 150° C., particularly in a roller mill having one or more passages.

Alternatively or in addition, the method according to the invention comprises the following method steps of: (i) roasting the coffee beans; (ii) cooling the coffee beans; (iii) measuring the temperature of the coffee beans during cooling; (iv) continuing with (ii) if the temperature is greater than a fixed target temperature, otherwise transferring the coffee beans into a grinding unit; (v) grinding the coffee beans, particularly in a roller mill having one or more passages; wherein the target temperature has a value of between 30° C. and 150° C., particularly between 35° C. and 100° C., preferably between 40° C. and 90° C., particularly preferably between 40° C. and 60° C.

The temperature is in this case measured continuously or at least at regular intervals. The typical intervals between two successive temperature measurements are in this case preferably 5-300 seconds. The measurement can also take place virtually continuously, for example in a control loop.

The object is also achieved by a method for processing coffee beans in a unit for grinding the beans, particularly as described above, in that the temperature of the grinding product is controlled before or during the grinding such that the temperature of the grinding product, at least at the start of the grinding operation, is between 30° C. and 150° C., particularly between 35° C. and 100° C., preferably between 40° C. and 90° C., particularly preferably between 40° C. and 60° C.

Preferably, to this end, the temperature of the unit for grinding, particularly a roller mill, more particularly one or more rollers, is controlled such that the temperature of the grinding product is between 30° C. and 150° C., particularly between 35° C. and 100° C., more particularly between 40° C. and 60° C., and particularly the temperature of the grinding tools of at least one grinding stage is controlled to temperatures between 30° C. and 150° C., particularly between 35° C. and 120° C., more particularly between 40° C. and 110° C., preferably between 40° C. and 90° C., particularly preferably between 60° C. and 80° C.

Since there is very close contact between the grinding tools and the grinding product, there is temperature equalization between the grinding product and the grinding tools and the grinding product absorbs the heat output by the grinding tools.

For example, roasted coffee is heated to about 45° C. by a roller having a temperature of 60° C.

Alternatively, a target temperature range of between 30° C. and 150° C., particularly between 35° C. and 100° C., more particularly between 40° C. and 60° C., for example a temperature range having a temperature span of ±2-10° C., can be selected.

Preferably, the method according to the invention has a method step in which the temperature of the roasted coffee is measured before, during and/or after grinding. The measured temperature can be used for monitoring purposes, or be used to adjust the temperature selected for example in a temperature-control unit.

Preferably, the temperature of the unit for grinding, particularly of the grinding tools, is controlled and/or regulated depending on the temperature of the grinding product.

The object is also achieved by a method, particularly as described above, in which the temperature of the grinding product and/or of the unit for grinding, particularly of the grinding tools, is set depending on the desired particle size distribution of the ground coffee, particularly such that the CO₂ content of the ground coffee immediately after grinding, or after a storage time of at most 20 hours, is below 0.5 ml/g.

For ground coffee having a maximum of the particle size distribution of about 500 μm, the grinding product can be ground for example at a temperature of about 50° C., in order that, after a degassing time of 7 hours after grinding, there remains only a gas content of 0.5 ml/g.

If the coffee is intended to be ground more coarsely, i.e. if there are coarser particles, it has proved advantageous for the grinding to be carried out at a higher temperature, for more finely ground coffee and smaller particles, the grinding can take place at cooler temperatures.

The following table shows the relationship between particle size, given here as median of the particle sizes, and preferred temperature of the grinding product.

| x50 [μm] | Temperature [° C.] |
|---|---|
| 504 | 46 |
| 328 | 28 |
| 134 | 15 |

The invention is explained in more detail in the following text with reference to drawings, in which:

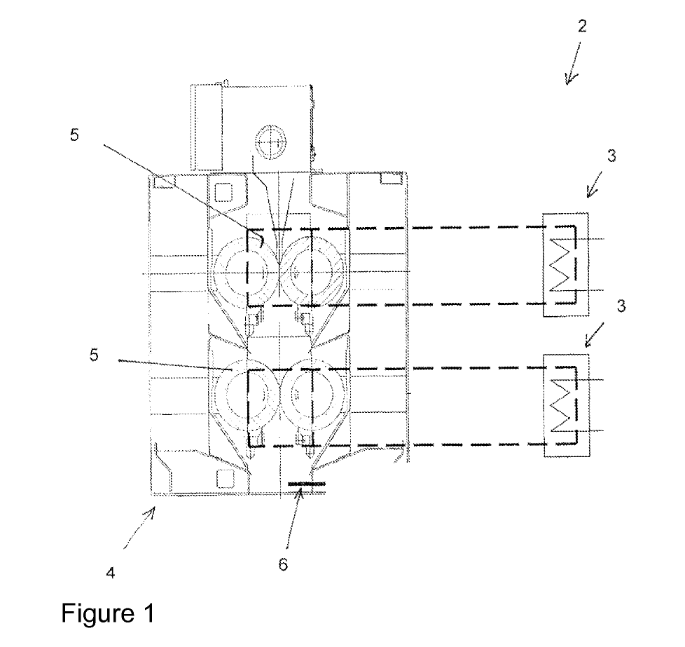

FIG. 1 shows a schematic illustration of a first example of an apparatus according to the invention having a temperature-control device for the grinding tools;

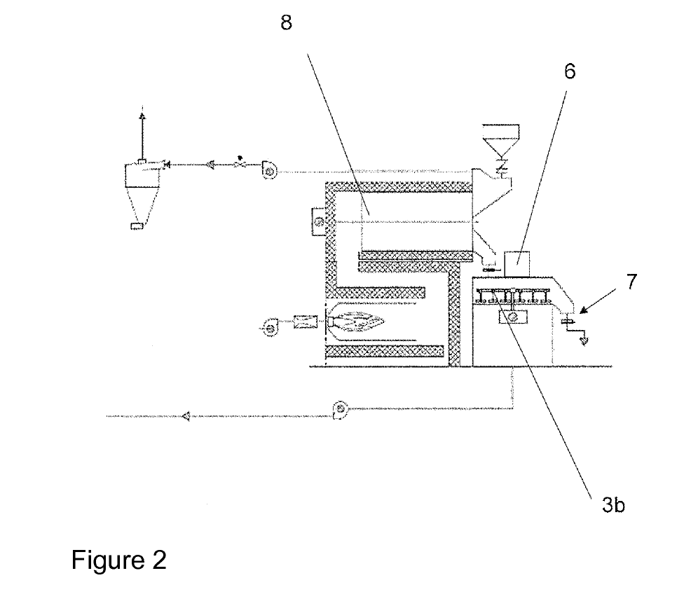

FIG. 2 shows a second example of an apparatus according to the invention having a temperature-control device and a device for feeding grinding product.

FIG. 1 shows a schematic illustration of an apparatus 1 according to the invention, having a thermal unit 2. In this case, the thermal unit 2 comprises a temperature-control device 3b for the unit for grinding 4, here temperature-control devices 3b for the grinding tools 5, which are pairs of rollers here.

The apparatus 1 comprises a measuring device 6 having a temperature sensor, which senses the temperature of the ground coffee.

The measured temperature is used to readjust the temperature-control devices 3b such that the grinding product is maintained at a particular target temperature.

FIG. 2 shows a second example of an apparatus according to the invention, having a temperature-control device 3a and a device 7 for feeding grinding product.

The coffee is first of all roasted in a roasting machine 8, a drum roaster here. Once roasting is complete, the coffee is passed into a temperature-control device 3a, in which air flows around the coffee and in the process cools it. The temperature-control device comprises a measuring device 6, by way of which the temperature of the coffee is monitored. Once the coffee has reached the temperature desired for grinding, the coffee passes through the device 7 for feeding grinding product and into the grinder, which is not shown in this figure.

The device 7 for feeding grinding product can be a bulk material valve which opens depending on a temperature, which is preferably fixed in advance. The valve can also receive a signal as soon as the measuring device 6 has determined a particular temperature value.

1. An apparatus for processing roasted coffee beans, wherein the apparatus comprises a thermal unit which ensures that the temperature of the roasted coffee beans during the grinding operation, at least at the start of the grinding operation, is between 30° C. and 150° C.

2. The apparatus as claimed in claim 1, wherein the thermal unit comprises a temperature-control device and a device for feeding grinding product, wherein the temperature-control device and the device for feeding grinding product are designed such that the temperature of the roasted coffee beans is controllable to temperatures of the grinding product between 30° C. and 150° C. for the start of the grinding operation, and the roasted coffee beans are grindable at these temperatures.

3. The apparatus as claimed in claim 1, having a unit for grinding the beans, wherein the thermal unit comprises a temperature-control device for the unit for grinding, said temperature-control device being designed such that the temperature of the grinding product is maintainable between 30° C. and 150° C.

4. The apparatus as claimed in claim 1, wherein the temperature-control device for the unit for grinding is a temperature-control device for grinding tools, said temperature-control device maintaining the grinding tools of at least one grinding stage at temperatures of between 30° C. and 150° C.

5. The apparatus as claimed in claim 1, wherein the temperature of the grinding product is controllable and/or regulatable via the thermal unit.

6. The apparatus as claimed in claim 1, wherein the apparatus comprises a measuring device for measuring the temperature of the roasted coffee before, during and/or after grinding.

7. The apparatus as claimed in claim 1, wherein the apparatus comprises a regulating device for controlling the temperature of the unit for grinding the beans, particularly for controlling the temperature of the grinding tools of at least one grinding stage, depending on the temperature of the grinding product.

8. The apparatus as claimed in claim 1, wherein the apparatus has an input and comparison means, by way of which the temperature of the grinding product is determined depending on the desired particle size distribution of the emerging grinding product.

9. A method for processing coffee beans, comprising the following method steps of:
(i) roasting the coffee beans;
(ii) cooling the coffee beans to temperatures greater than 66° C.;
(iii) grinding the coffee beans at temperatures of between 66° C. and 150° C.

10. The method, particularly as claimed in claim 9, comprising the method steps of:
(i) roasting the coffee beans;
(ii) cooling the coffee beans;
(iii) measuring the temperature of the coffee beans during cooling;
(iv) continuing with (ii) if the temperature is greater than a fixed target temperature, otherwise transferring the coffee beans into a grinding unit;
(v) grinding the coffee beans,
wherein the target temperature has a value of between 30° C. and 150° C.

11. The method for processing coffee beans in a unit for grinding the beans, particularly as claimed in claim 9, wherein the temperature of the grinding product is controlled before or during the grinding such that the temperature of the grinding product, at least at the start of the grinding operation, is between 30° C. and 150° C.

12. The method as claimed in claim 9, wherein the temperature of the unit for grinding is controlled such that the temperature of the grinding product is between 30° C. and 150° C., and particularly the temperature of the grinding tools of at least one grinding stage is controlled to temperatures between 30° C. and 150° C.

13. The method as claimed in claim 9, wherein the temperature of the roasted coffee is measured before, during and/or after grinding.

14. The method as claimed in claim 9, wherein the temperature of the unit for grinding, particularly of the grinding tools, is controlled and/or regulated depending on the temperature of the grinding product.

15. The method, particularly as claimed in claim 9, wherein the temperature of the grinding product and/or of the unit for grinding, particularly of the grinding tools, is set depending on the desired particle size distribution of the ground coffee, particularly such that the CO₂ content of the ground coffee is below 0.1 ml/g.

16. The apparatus as claimed in claim 1, wherein the start of the grinding operation, is between 35° C. and 100° C.

17. The apparatus as claimed in claim 1, wherein the start of the grinding operation, is between 40° C. and 90° C.

18. The apparatus as claimed in claim 1, wherein the start of the grinding operation, is between 40° C. and 60° C.

19. The apparatus as claimed in claim 1, wherein the temperature of the roasted coffee beans is controllable to temperatures of the grinding product between 35° C. and 100° C., for the start of the grinding operation, and the roasted coffee beans are grindable at these temperatures.

20. The apparatus as claimed in claim 1, wherein the temperature of the roasted coffee beans is controllable to temperatures of the grinding product between 40° C. and 90° C., for the start of the grinding operation, and the roasted coffee beans are grindable at these temperatures.

21. The apparatus as claimed in claim 1, wherein the temperature of the roasted coffee beans is controllable to temperatures of the grinding product between 40° C. and 60° C., for the start of the grinding operation, and the roasted coffee beans are grindable at these temperatures.

22. The apparatus as claimed in claim 1, wherein the temperature of the grinding product is maintainable between 35° C. and 100° C.

23. The apparatus as claimed in claim 1, wherein the temperature of the grinding product is maintainable between 40° C. and 90° C.

24. The apparatus as claimed in claim 1, wherein the temperature of the grinding product is maintainable between 40° C. and 60° C.

25. The apparatus as claimed in claim 1, wherein the temperature-control device maintaining the grinding tools of at least one grinding stage at temperatures of between 35° C. and 120° C.

26. The apparatus as claimed in claim 1, wherein the temperature-control device maintaining the grinding tools of at least one grinding stage at temperatures of between 40° C. and 110° C.

27. The apparatus as claimed in claim 1, wherein the temperature-control device maintaining the grinding tools of at least one grinding stage at temperatures of between 40° C. and 90 ° C.

28. The apparatus as claimed in claim 1, wherein the temperature-control device maintaining the grinding tools of at least one grinding stage at temperatures of between 40° C. and 60° C.

29. The apparatus as claimed in claim 1, wherein the temperature-control device maintaining the grinding tools of at least one grinding stage at temperatures of between 60° C. and 80° C.

30. The method, particularly as claimed in claim 9, wherein the target temperature has a value of between 35° C. and 100° C.

31. The method, particularly as claimed in claim 9, wherein the target temperature has a value of between 40° C. and 90° C.

32. The method, particularly as claimed in claim 9, wherein the target temperature has a value of between 40° C. and 60° C.

33. The method for processing coffee beans as claimed in claim 9, the temperature of the grinding product, at least at the start of the grinding operation, is between 35° C. and 100° C.

34. The method for processing coffee beans as claimed in claim 9, the temperature of the grinding product, at least at the start of the grinding operation, is between 40° C. and 90° C.

35. The method for processing coffee beans as claimed in claim 9, the temperature of the grinding product, at least at the start of the grinding operation, is between 40° C. and 60° C.

36. The method as claimed in claim 9, wherein the temperature of the unit for grinding is controlled such that the temperature of the grinding product is between 30° C. and 150° C., and the temperature of the grinding tools of at least one grinding stage is controlled to between 35° C. and 120° C.

37. The method as claimed in claim 9, wherein the temperature of the unit for grinding is controlled such that the temperature of the grinding product is between 30° C. and 150° C., and the temperature of the grinding tools of at least one grinding stage is controlled to between 40° C. and 110° C.

38. The method as claimed in claim 9, wherein the temperature of the unit for grinding is controlled such that the temperature of the grinding product is between 35° C. and 100° C., and the temperature of the grinding tools of at least one grinding stage is controlled to between 40° C. and 90° C.

39. The method as claimed in claim 9, wherein the temperature of the unit for grinding is controlled such that the temperature of the grinding product is between 35° C. and 100° C., and the temperature of the grinding tools of at least one grinding stage is controlled to between 40° C. and 60° C.

40. The method as claimed in claim 9, wherein the temperature of the unit for grinding is controlled such that the temperature of the grinding product is between 35° C. and 100° C., and the temperature of the grinding tools of at least one grinding stage is controlled to between 60° C. and 80° C.
